(19) United States
(12) Patent Application Publication
(10) Pub. No.: US 2026/0004082 A1
(43) Pub. Date: Jan. 1, 2026

(54) SYSTEMS AND METHODS FOR SCORING LANGUAGE MODEL OUTPUTS USING A SCORING MODEL

(71) Applicant: CABLE TELEVISION LABORATORIES, INC., Louisville, CO (US)

(72) Inventors: Jason W. Rupe, Lafayette, CO (US); Paul Fonte, Arvada, CO (US); Tyler Glenn, Kalispell, MT (US); Kyle Haefner, Fort Collins, CO (US); Tiago Souto, São Paulo (BR); Damir Kadic, Sarajevo (BA)

(21) Appl. No.: 19/322,416

(22) Filed: Sep. 8, 2025

Related U.S. Application Data
(63) Continuation-in-part of application No. 19/222,001, filed on May 29, 2025.
(60) Provisional application No. 63/653,106, filed on May 29, 2024.
(60) Provisional application No. 63/691,923, filed on Sep. 6, 2024.
(60) Provisional application No. 63/722,488, filed on Nov. 19, 2024.
(60) Provisional application No. 63/757,616, filed on Feb. 12, 2025.

(51) Int. Cl. G06F 40/30; G06F 16/3329

(52) U.S. Cl. CPC G06F 40/30; G06F 16/3329

(57) ABSTRACT

Systems and methods for scoring language model outputs using a scoring model are provided. At least one input information and at least one output from a language model may be received as input by a scoring language model. The scoring language model may be configured to score the at least one output based on the at least one input information to yield an output score. A user interface may output the output score and the output from the language model.

### CROSS REFERENCE TO RELATED APPLICATIONS

This application is a continuation-in-part of co-pending U.S. application Ser. No. 19/222,001, filed on May 29, 2025, which claims the benefit of and priority to U.S. Provisional Application Nos. 63/653,106, filed on May 29, 2024 and 63/757,616, filed on Feb. 2, 2025, each of which applications are incorporated herein by reference in their entireties. This application also claims the benefit of and priority to U.S. Provisional Application Nos. 63/691,923, filed on Sep. 6, 2024 and 63/722,488, filed on Nov. 19, 2024.

### BACKGROUND

The field of the disclosure relates generally to scoring language model outputs, and more particularly, to scoring language model outputs using a scoring model.

Network as a Service (NaaS) is a common application programming interface (API) across operators targeting multi-access networks that enables network-aware application deployment and enhanced performance. NaaS enables developers, internal operations, and hyperscalers the ability to request network services, exchange data, and automate deployment of applications. By leveraging standard intent-based APIs that expose network services and data while reducing the complexity and domain knowledge of the underlying access technology, new relationships between network operators and third-party developers can be established more seamlessly.

However, end users and Multiple System Operators (MSOs) may become frustrated when, for example, an end user's internet does not work properly at the desired location. If the end user's internet appears to be running slowly or a video conference call or a tv show freezes and/or buffers, then the end user may get frustrated with the MSO. In such instances, determining the root cause of the issue can be difficult for both the end user and the MSO as there is currently no communication system between the end user's application and the network.

In a different application, generative AI (GAI) provides for the accumulation of knowledge from experts, encodes the knowledge for fast access, and can incorporate situational information to create an equivalence of an expert assistant. More specifically, language models and large language models (LLM) can provide information that is immediately useful to a user. Such GAI and LLMs can be used to, for example provide training for entry level or new employees to a company. However, language models and LLMs do not always provide accurate outputs or answers. In some embodiments, the language models or the LLM may use Retrieval Augmented Generation (“RAG”), which references an external knowledge base to improve the accuracy of the output from the LLM.

Though LLMs with RAG can improve the accuracy of the output, the LLM may still produce outputs with inaccuracies. Thus, it is desirable to evaluate and validate out puts from the LLM (with or without RAG). However, conventional evaluation tools have difficulty accurately evaluating the output and detecting hallucinations when the output being evaluated is not worded the same as an expected output, contains additional true information, or is lacking information. For example, conventional evaluation tools may compare the expected output and the output. However, such comparison may falsely label the output as inaccurate if the expected output and the output are not similarly worded, even if the output is accurate. Thus, validating an accuracy of an output from an LLM remains a challenge.

### SUMMARY

Systems and methods are provided for automatically evaluating and validating an output from a language model (which may be, for example, a large language model (LLM)) using an improved scoring model. The scoring model receives an output from the language model and input information (including, for example, scoring guidelines, an expected output, a user query, etc.) as input and outputs an output score and in some instances, a rationale for the output score. The scoring model can more accurately evaluate the output from the language model by inclusively evaluating the output based on several factors such as the input information, expected output, etc.

Example aspects of the present disclosure include:

A method according to at least one embodiment of the present disclosure comprises receiving at least one input information; receiving at least one output from a language model; inputting the at least one input information and the at least one output into a scoring language model configured to score the at least one output based on the at least one input information to yield an output score; and outputting the at least one output from the language model and the output score.

Any of the aspects herein, wherein the language model uses a retrieval-augmented generation (RAG) configured to search an external knowledge base and generate a RAG context.

Any of the aspects herein, wherein the external knowledge base includes at least one content that is certified through a certification process of one or more certification processes.

Any of the aspects herein, wherein the certification process is selected based on a type of the at least one content.

Any of the aspects herein, wherein the certification process assigns a certification level to the at least one content based on at least one of the type of content and a number of steps taken during the certification process to certify the at least one content.

Any of the aspects herein, wherein the at least one content is weighted based on the assigned certification level.

Any of the aspects herein, wherein the at least one input information includes one or more scoring guidelines, a user query, a RAG context of the user query, an expected output, and an expected RAG context of the user query.

Any of the aspects herein, wherein the one or more scoring guidelines includes at least one of measuring an accuracy of the at least one output relative to the RAG context, measuring a relevancy of the at least one output to the user query, measuring an accuracy of the at least one output relative to the user query, measuring an accuracy of the RAG context to the expected RAG context, and measuring a relevancy of the RAG context to the user query.

Any of the aspects herein, wherein the RAG context of the user query is received from a RAG.

Any of the aspects herein, wherein the scoring language model further generates an output score rationale, and wherein the method further comprises outputting the output score rationale with the output score and the at least one output.

Any of the aspects herein, wherein outputting the at least one output and the output score comprises displaying the at least one output and the output score in a graphical user interface (GUI) on a display.

Any of the aspects herein, wherein the output score includes a plurality of output scores.

A system according to at least one embodiment of the present disclosure comprises a language model in communication with a user interface and configured to receive a user query as input and to output an output based on the user query; a scoring language model in communication with the language model and the user interface, the scoring model configured to: receive, as input, the output and at least one input information; score the output based on the at least one input information; and yield an output score; and the user interface configured to display the output and the output score.

Any of the aspects herein, wherein the language model uses a retrieval-augmented generation (RAG) configured to search an external knowledge base and generate a RAG context.

Any of the aspects herein, wherein the external knowledge base includes at least one content that is certified through a certification process of one or more certification processes.

Any of the aspects herein, wherein the at least one input information includes one or more scoring guidelines, a user query, a RAG context of the user query, an expected output, and an expected RAG context of the user query.

Any of the aspects herein, wherein the one or more scoring guidelines includes at least one of measuring an accuracy of the at least one output relative to the RAG context, measuring a relevancy of the at least one output to the user query, measuring an accuracy of the at least one output relative to the user query, measuring an accuracy of the RAG context to the expected RAG context, and measuring a relevancy of the RAG context to the user query.

Any of the aspects herein, wherein the RAG context of the user query is received from a RAG.

Any of the aspects herein, wherein the scoring language model further generates an output score rationale, and wherein the method further comprises outputting the output score rationale with the output score and the at least one output.

A system according to at least one embodiment of the present disclosure comprises a language model in communication with a user interface and a RAG, the language model configured to receive a user query from the user interface and a RAG context from the RAG as input and to output an output based on the user query and the RAG context; a scoring language model in communication with the language model and the user interface, the scoring model configured to: receive, as input, the output, an expected output, the user query, the RAG context, an expected RAG context, and one or more scoring guidelines; score the output based on the one or more scoring guidelines and the expected output, the user query, the RAG context, and the expected RAG context; and yield an output score and a score rationale; and the user interface configured to display the output, the output score, and the score rationale.

The details of one or more aspects of the disclosure are set forth in the accompanying drawings and the description below. Other features, objects, and advantages of the techniques described in this disclosure will be apparent from the description and drawings, and from the claims.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a schematic illustration of a system that uses Network as a Service (Naas) according to at least one embodiment of the present disclosure;

FIG. 2 is a schematic diagram of a system for estimating a network quality according to at least one embodiment of the present disclosure;

FIG. 3 is an example graphical user interface according to at least one embodiment of the present disclosure;

FIG. 4 is a dataflow according to at least one embodiment of the present disclosure;

FIG. 5 is a logical topology according to at least one embodiment of the present disclosure;

FIG. 6A is a schematic diagram of training a scoring model according to at least one embodiment of the present disclosure;

FIG. 6B is a schematic diagram of a structure of the scoring model according to at least one embodiment of the present disclosure;

FIG. 7 is a flowchart according to at least one embodiment of the present disclosure;

FIG. 8 is a flowchart according to at least one embodiment of the present disclosure;

FIG. 9 is a schematic diagram of a validation system for a language model according to at least one embodiment of the present disclosure;

FIG. 10 is a detailed schematic diagram of a validation system for a language model according to at least one embodiment of the present disclosure;

FIG. 11 is a dataflow according to at least one embodiment of the present disclosure; and

FIG. 12 is a table illustrating tests results of a scoring model according to at least one embodiment of the present disclosure.

### DETAILED DESCRIPTION

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (i.e., X₁ and X₂) as well as a combination of elements selected from two or more classes (i.e., Y₁ and Zₒ).

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, i.e., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “agent” is a computer program that can perform tasks autonomously or semi-autonomously on behalf of a user or a system. In other words, the agent can operate independently of a human user or operator.

Furthermore, as used herein, the term “real-time” refers to at least one of the time of occurrence of the associated events, the time of measurement and collection of predetermined data, the time for a computing device (i.e., a processor) to process the data, and the time of a system response to the events and the environment. In the embodiments described herein, these activities and events occur substantially instantaneously.

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, i.e., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

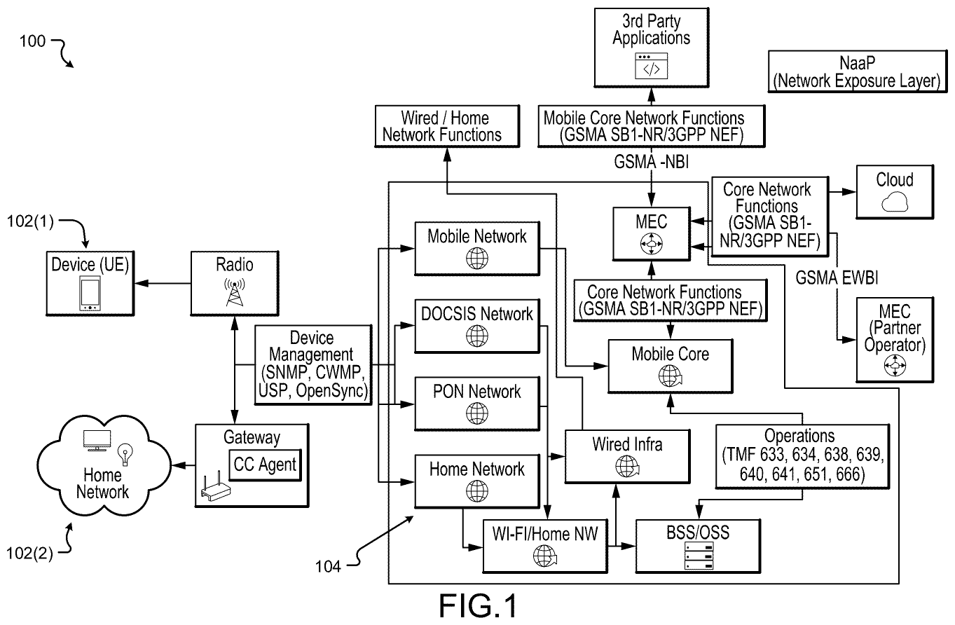

Turning to FIG. 1, a schematic illustration depicting a Network as a Service (NaaS) system (100) is provided for reference. As shown, multiple end users (102(1)), (102(2)) may access multiple networks (104) via the NaaS system (100). However, as previously described, a conventional NaaS system (100) cannot identify a location or root cause of an issue that occurs at an end user (102). For example, the root cause may be an issue at one of the networks (104); however, network data to determine such issue is not available to the end user (102). Similarly, the root cause may be an issue at the end user (102); however, end user data such as application key performance indicators (KPIs) are not available to the networks (104). Thus, it is desirable to monitor a quality of the end user's (102) network user to: determine when the end user's (102) use is impaired by quantifying the network quality using a scoring model, to identify a type and a location of the impairment, and to determine a resolution action for the impairment.

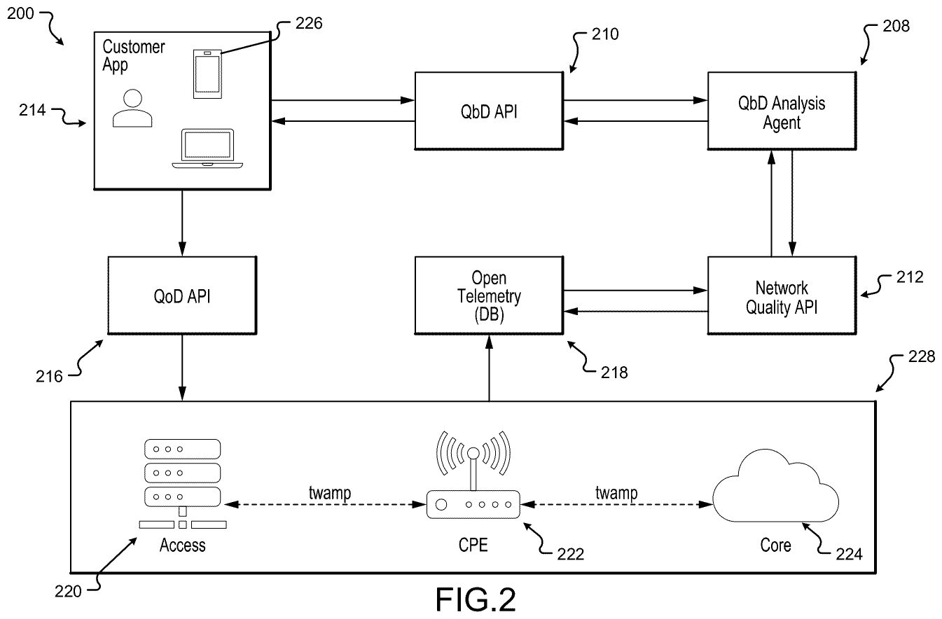

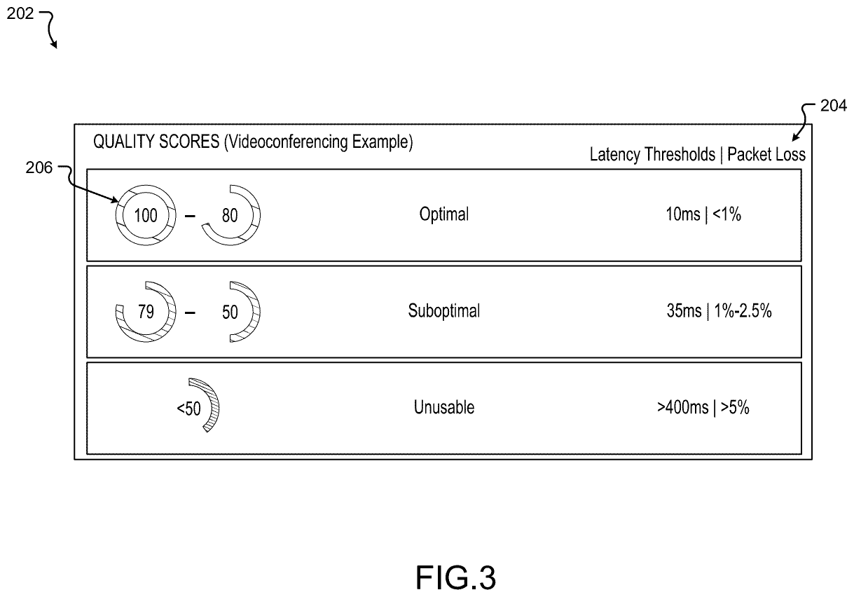

Turning to FIGS. 2 and 3, a schematic diagram of a system (200) for determining an impairment to an end user's network connection by quantifying the network quality and an example graphical user interface (GUI) (202) of predetermined thresholds (204) are respectively shown. The system (200) is used to monitor a quality of the end user's (102) use by determining an end user score (236) (labelled in FIGS. 3, 4, 5, 6A, and 6B) based on data received from the end users (102) and the networks (104) and determining a resolution action when the end user (102) experiences an impairment to their use.

As shown in FIG. 2, the system (200) includes an analysis agent (208) in communication with a first API (210) and a second API (212). The analysis agent (208) is an agent that can perform tasks related to receiving and analyzing application KPI(s) and network data. The analysis agent (208) can, for example, run a scoring model (234) using the application KPI(s), network data, and other measurements as input into the scoring model (234).

The first API (210) is also in communication with an end user application (214) and the second API (212) is also in communication with a data collector (218). The end user application (214) is also in communication with a third API (216), which may be in communication with an access network (220). The access network (220) is also in communication with a customer premises equipment (CPE) (222), which is in communication with a core network (224). The data collector (218) is also in communication with the CPE (222).

The first API (210) may be referred to as a gateway or quality by design API, the second API (212) may be referred to as a network quality API, and the third API (216) may be referred to as a quality on demand API. It will be appreciated that the first API (210), the second API (212), the third API (216), or any API may be, for example, a CAMARA based API.

The end user application (214) operates on a user device (226) such as, for example, a smart phone, a smart watch, a computing device, a laptop, or the like. The end user application (214) also operates over a network (228) via the NaaS system (100).

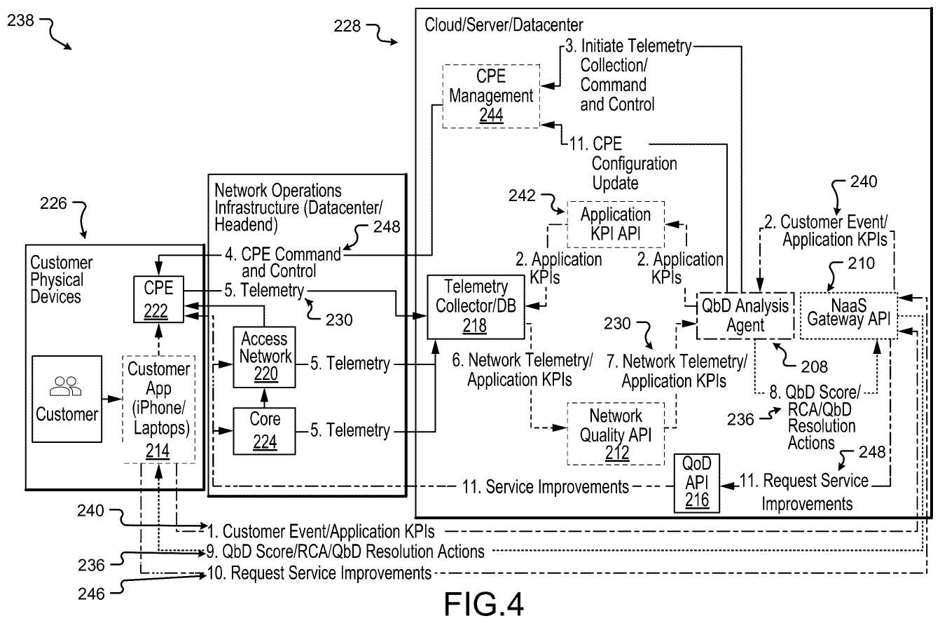

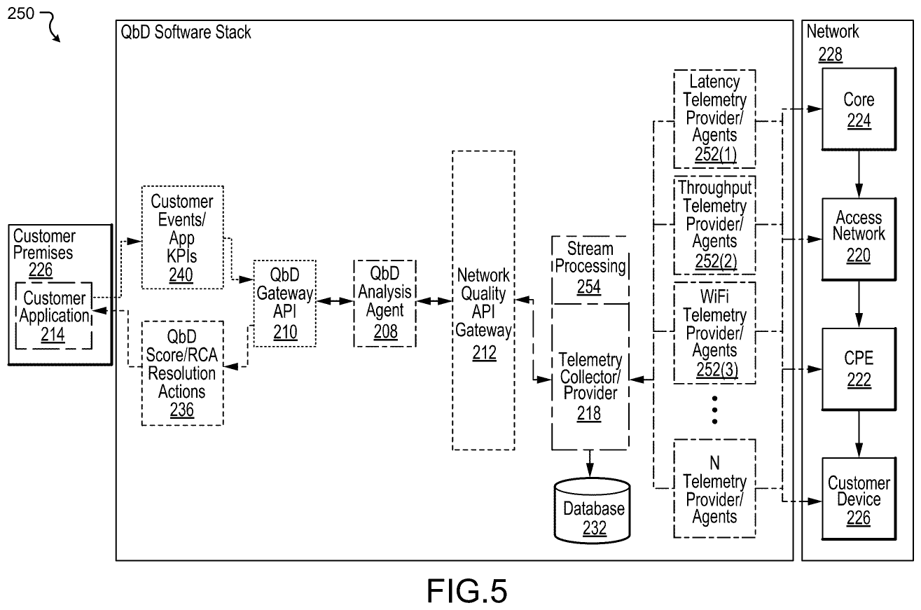

The CPE (222), the access network (220), and the core network (224) may be collectively part of the network (228). The CPE (222) may be, for example, a gateway and/or an access point and the core network (224) may be of a network operator (e.g., an MSO). Network data (230) (shown in FIG. 4) may be collected from the network (228) by the data collector (218). The data collector (218) may transmit such network data (230) to the analysis agent (208) in real-time. The data collector (218) may also store the data in a database (232) (shown in FIG. 5B).

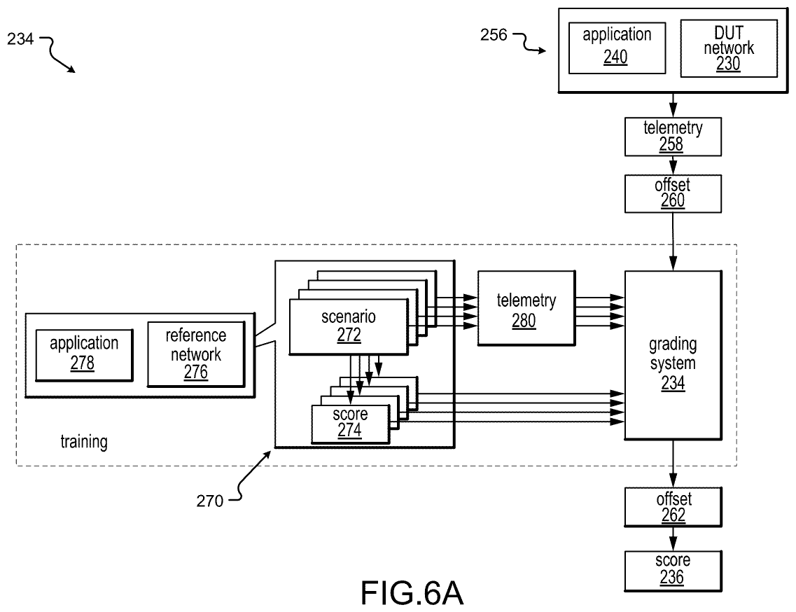

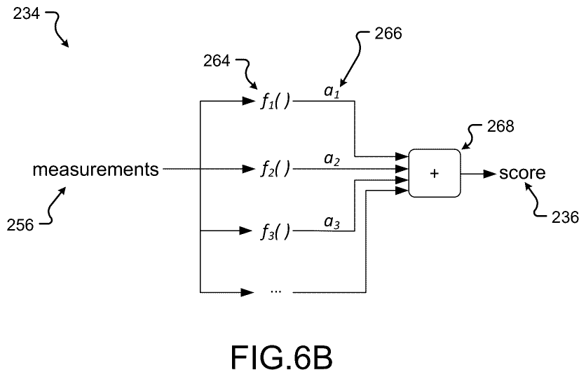

During use, the analysis agent (208) receives real-time measurements (256) (labelled in FIG. 6A) or measurements (256) from the database (232). The measurements (256) may be, for example, application KPIs (240) (labelled in FIG. 4) received from the end user application (214) via the first API (210). The network data (230) may be received from the data collector (218) (or the database (232)) via the second API (212). It will be appreciated that in some embodiments, the measurements (256) may be collected or measured in the cloud and stored in the database (232). The analysis agent (208) uses the measurements (256) as input into a scoring model (234) (shown in FIGS. 6A and 6B) to generate or output an end user score (236) that is compared to the at least one predetermined threshold (204) (shown in FIG. 3). Details of the scoring model are discussed in FIGS. 6, 7, AND 8.

As shown in FIG. 3, the at least one predetermined threshold (204) includes three ranges of predetermined thresholds displayed on an example GUI (202). In other embodiments, the at least one predetermined threshold (204) may include one predetermined threshold, two predetermined thresholds, or more than two predetermined thresholds. In the illustrated embodiment, the predetermined thresholds (204) and corresponding end user scores (236) include, for example:
Optimal=(Score) 100-80: (Threshold) latency 10 ms, packet loss <1%;
Suboptimal=(Score) 79-50: (Threshold) latency 35 ms, packet loss 1%-5%; and
Unusable=(Score) <50: (Threshold) latency >400 ms, packet loss >5%.

Turning to FIG. 4, a dataflow (238) of the system (200) is shown. The arrows in the topology and flow represent a direction of the communication, data, instructions, and/or telemetry. Additionally, the numbering may represent the order of the steps in the flow according to one embodiment. However, in other embodiments, the steps can occur in a different order. In some embodiments, some steps are in consecutive order (i.e., run in series) and other steps can occur at the same time (i.e., run in parallel). Some steps may also occur continuously while other steps may occur at a time interval or when requested. Lastly, the dataflow (238) may include more or less steps.

As shown, application KPIs (240) may be received by the first API (210) from the end user application (214). The application KPIs (240) may include one application KPI, two application KPIs, or more than two application KPIs. The application KPIs (240) may be, for example, bandwidth, framerate, packet latency, jitter, bit rate, and/or packet loss. The application KPIs (240) may be continuously received or received at a time interval (e.g., every 10 seconds, every minute, etc.) by the first API (210). It will be appreciated that the first API (210) can request, receive, and/or send the application KPIs (240), the end user scores (236), root cause analysis results, and/or resolution actions. After the first API (210) receives the application KPIs (240), the first API (210) transmits the application KPIs (240) to the analysis agent (208). The application KPIs (240) may also simultaneously or sequentially be sent to an application KPI API (242), which communicates with the database (232) to store the application KPIs (240) in the database (232).

The analysis agent (208) then requests or receives network data (230). The network data (230) may be data from the CPE (222), the access network (220), and/or the core network (224). More specifically, the network data (230) may be received from the CPE (222) via a CPE management (244), which is in communication with the CPE (222) and the analysis agent (208). In such instances, the analysis agent (208) may send a command (248) to the CPE (222) to receive network data. The CPE management (244) is also a control interface that can also increase the sending/receiving of the network data (230).

The CPE (222) is in communication with the database (232) and/or data collector (218) and may transmit network data (230) to the database (232) and/or the data collector (218). The network data (230) may also be received from the access network (220) and/or the core network (224) by the database (232) and/or the data collector (218). It will be appreciated that the network data (230) may be received and/or stored continuously, at a time interval, or by request. The third API (216) can also instruct the core network (224) and access network (220) to increase a speed of the network data (230) sent and/or increase the frequency and amount of network data (230) sent. The network data (230) may include, for example, KPIs such as packet latency, jitter, bit rate, packet loss, and/or other data.

The network data (230) is received by the analysis agent (208) from the database (232) and/or the data collector (218) via the second API (212). It will be appreciated that the second API (212) can request, receive, and/or send real-time network conditions, telemetry, and historical device measurements. As previously described, the analysis agent (208) uses the application KPIs (240) and the network data (230) (also referred to collectively as “measurements (256)”) to generate the end user score (236). The analysis agent (208) then compares the end user score (236) to the predetermined threshold (204) to determine whether the end user application (214) is experiencing an impairment.

If the end user application (214) is determined to be experiencing an impairment (e.g., the end user score is less than the predetermined threshold), then the analysis agent (208) can identify a type of impairment and/or a location of the impairment by conducting a root cause analysis. The root cause analysis may be conducted by, for example, process of elimination. In one example, the end user device's Wi-Fi connection may be checked by requesting network data and KPIs from the CPE (222), the access network (220) may be checked by requesting access network telemetry and KPIs, and the core network (224) may be checked by requesting core telemetry and KPIs. If the telemetry and KPIs for the Wi-Fi, CPE, access network, and core network are satisfactory, then the analysis agent (208) looks at the end user application (214) for the impairment. For example, is there Wi-Fi congestion on the end user's private network or is there upstream noise? If there is Wi-Fi congestion, then a resolution action to repair or improve the impairment can be identified such as prioritizing some applications and/or devices over other applications and/or devices. It will be appreciated that the root cause analysis can run through any number of scenarios to determine the impairment.

The analysis agent (208) can transmit the end user score (236), the root cause analysis, and/or the resolution action(s) to the end user application (214). In response, the end user application (214) can transmit a service improvement request (246) to the first API (210), which communications with the third API (216). The third API (216) can request, receive, and/or send actionable network optimizations, which may be automated or initiated by a user such as the end user, a developer, or a network operator. Further, the third API (216) can perform, for example, a speed boost, Wi-Fi MulitMedia packet marking, low latency DOCSIS, and low latency and low loss (L4S), among other actions in response to the service improvement request (246).

The third API (216) executes service improvements (248) based on the type and location of resolution or repair needed. For example, if the impairment is on the end user's Wi-Fi, then the first API (210) sends instructions to the third API (216), which then requests service improvements on the CPE (222). If the impairments are on the core network (224) or the access network (220), then the third API (216) requests service improvements on the access network (220) or the core network (224), which may include notifying the network operator of the impairment and resolution action.

Turning to FIG. 5, a logical topology (250) of the system (200) is shown. The logical topology (250) illustrates an example flow of data from the end user device (226) to the analysis agent (208) and from the network (228) to the analysis agent (208).

As previously described, application KPIs (240) are received by the analysis agent (208) via the first API (210) and network data (230) is received by the analysis agent (208) via the second API (212). The network data (230) may be received from the data collector (218), which collects the network data (230) from the network (228) components such as, for example, the core network (224), the access network (220), the CPE (222), and/or the end user device (226). The network data (230) may be provided by one or more telemetry data agents (252) for each type of data collected. For example, latency data may be measured by a latency agent (252(1)), throughput data may be measured by a throughput agent (252(2)), Wi-Fi data may be measured by a Wi-Fi agent (252(3)), etc. The network data (230) may also be stored in the database (232). In embodiments where the network data (230) is collected in real-time, the network data (230) can be collected and processed by a stream processor (254) rather than stored in the database (232).

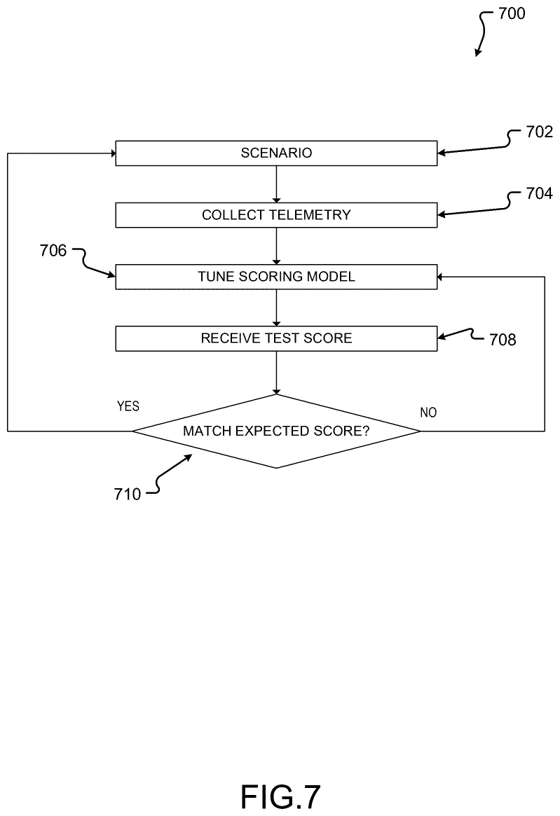

Turning to FIGS. 6A, 6B, and 7, a schematic diagram of training the scoring model (234), the scoring model (234), and a flow chart are respectively shown. As previously described, the scoring model (234) receives the measurements (256), which may be application KPIs (240) and network data (230), and outputs the end user score (236). The end user score (236) correlates to whether the end user application (214) is experiencing an impairment (e.g., the internet connection is unstable, low quality, and/or not functioning). The end user score (236) may be, for example, a scalar value that correlates to a grade that presents the health of current network operation. It will be appreciated that the scoring model (234) can be used in any application or use.

As shown in FIG. 6, measurements (256) such as application KPIs (240) and network data (230) from a network under testing may be transmitted via telemetry (258) to the scoring model (234). One or more offsets (260) may be applied to one or more measurements of the measurements (256) to, for example, match an effective region of the scoring model (234). In other words, the measurements (256) may be normalized before being inputted into the scoring model (234). The scoring model (234) then outputs the end user score (236) and an offset or adjustment (262) can be applied to the end user score (236) to match a scale (e.g., 1 to 100) and/or more accurately reflect a health of the network (228).

As shown in FIG. 7, the scoring model (234) specifically receives the measurements (256) and inputs the measurements (256) into one or more functions (264). Each function (264) outputs a value and the values from each function (264) are combined or summed at a summing function (268) to output the end user score (236). Each function (264) is also weighted by a weight (266), which can be set automatically or manually by a user such as, for example, a developer. The functions (264) may be, for example, mapping algorithms that are linear mapping, non-linear mapping (for example, polynomial mapping), machine learning, or kernal regression mapping. It will be appreciated that the functions (264) can be any type of function (264) and may include any number of functions (264) such as one function, two functions, or more than two functions. The weights (266) can be used to balance or weight the scoring model (234) between the different functions (264). For example, the weights (266) can be used to bias the scoring model (234) to be more linear, as will be illustrated in the example below.

In one specific example, each group of measurements (256) containing M-number of measurement values can be denoted as a vector x∈

[symbol]

and the output end user score y can be expressed as:

$$y = {\sum }_{i} {a}_{i} {f}_{i} ( x ) \qquad {\sum }_{i} {a}_{i} = 1$$

Where αᵢ are the weights (266) and ƒᵢ are the functions (264). It will be appreciated that ƒᵢ may include any number of functions such as one function, two functions, or more than three functions. In the illustrated example, ƒᵢ may have three functions where ƒ₁ is a linear mapping, ƒ₂ is a polynomial mapping, and ƒ₃ is a kernel regression mapping. In some instances, ƒᵢ may be a machine learning model. Thus, to weight the scoring model (234) as a linear model, αᵢ can be set as α₁=1 and α₂ and α₃=0. The weights (266) can also be used to balance or adjust the functions with respect to telemetry features and telemetry samples.

Returning to FIG. 6, the scoring model (234) is derived through training using training data (270). Such training data (270) may be labelled training data and can be used to train each function of the one or more functions (264). More specifically, the training data (270) can include scenarios (272) that are created from a physical reference network (276) and/or a simulation (278). The scenarios (272) can be used to produce test measurements (256) and resulting test end user scores (274) that are transmitted to the scoring model (234) via telemetry (280). For example, noise may be applied to a reference network to create a scenario (e.g., an impaired network connection) and an end user score may be given to the performance of the reference network under such scenario. Such measurements obtained from the scenario and the end user score given may then be used as training data.

The scoring model (234) can also alternatively be trained in an iterative process as shown in a method (700) of FIG. 7. As shown, the method (700) begins with a step (702) of executing a scenario, which produces measurements. The measurements are collected at a step (704) and inputted into the scoring model at a step (706). A test score is received at a step (708). The test score is compared to an expected score at a step (710). If the test score matches or matches the expected score within a predetermined range, then the method (700) repeats with a new scenario. If the test score does not match or does not match within a range with the expected score, then the scoring model and/or the measurements that are inputted into the scoring model are adjusted and a new test score is received. Such loop (e.g., adjusting the scoring model and/or the inputs) may be repeated until the test score matches the expected score or matches the expected score within a range.

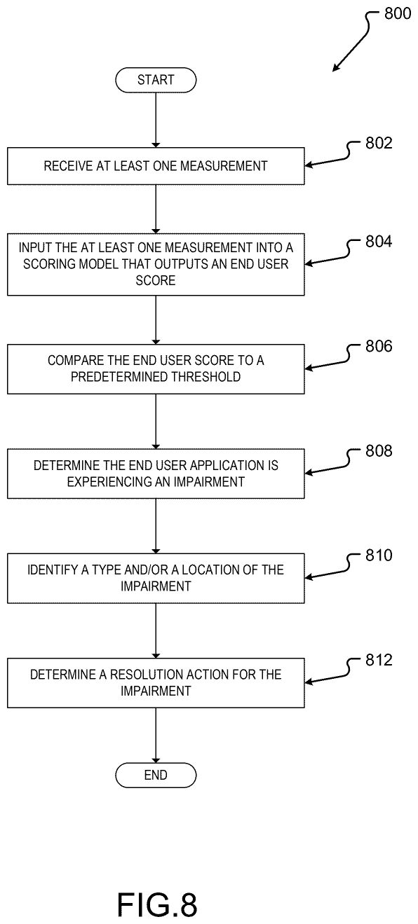

Turning to FIG. 8, a flowchart for a method 800 is provided. The method 800 may be used to determine whether an impairment is present in a network connection and to provide a resolution action for the impairment.

The method 800 includes receiving at least one measurement at step 802. The at least one measurement may be the same as or similar the measurements (256) and may be received by an analysis agent such as the analysis agent (208). As previously described, the measurements may include application KPIs such as the application KPIs (240) and network data such as the network data (230) obtained via telemetry. The application KPIs may be received from an end user application such as the end user application (214) via a first API such as the first API (210) and the network data may be received from a network such as the network (228) via a second API such as the second API (212).

The method 800 also includes inputting the at least one measurement into a scoring model that outputs an end user score at step 804. The analysis agent may input the measurement into the scoring model, which may be the same as or similar to the scoring model (234) and the end user score may be the same as or similar to the end user score (236). As previously described, the scoring model may receive the measurements and input each set of measurements into one or more functions. Each function outputs a value and the values are summed to generate the end user score. Each function is also weighted by a corresponding weight.

The method 800 also includes comparing the end user score to a predetermined threshold at step 806. The analysis agent may compare the end user score to the predetermined threshold, which may be the same as or similar to the predetermined threshold (204). The predetermined threshold may correlate to whether the end user application is experiencing an impairment such as, for example, an impairment to the end user's Wi-Fi connection.

The method (800) also includes determining that the end user application is experiencing an impairment at step (808). The end user application may be determined to be experiencing an impairment by the analysis agent when, for example, the end user score meets or is below the predetermined threshold. In other embodiments, the end user application may be determined to be experiencing an impairment when, for example, the end user score meets or is above the predetermined threshold.

The method (800) also includes identifying a type and/or a location of the impairment in step (810). Identifying the type and/or the location of the impairment may include conducting a root cause analysis by the analysis agent, as described in FIG. 4.

The method (800) also includes determining a resolution action for the impairment in step (812). The analysis agent may also determine the resolution action for the impairment based on the identified type and/or location of the impairment, as described in FIG. 4. The resolution action may also be transmitted to the end user application by the analysis agent, which may result in execution of the resolution action.

The method (800) may include more or less steps than described above. Further, any of the steps or any combination of steps may be repeated or continuously executed.

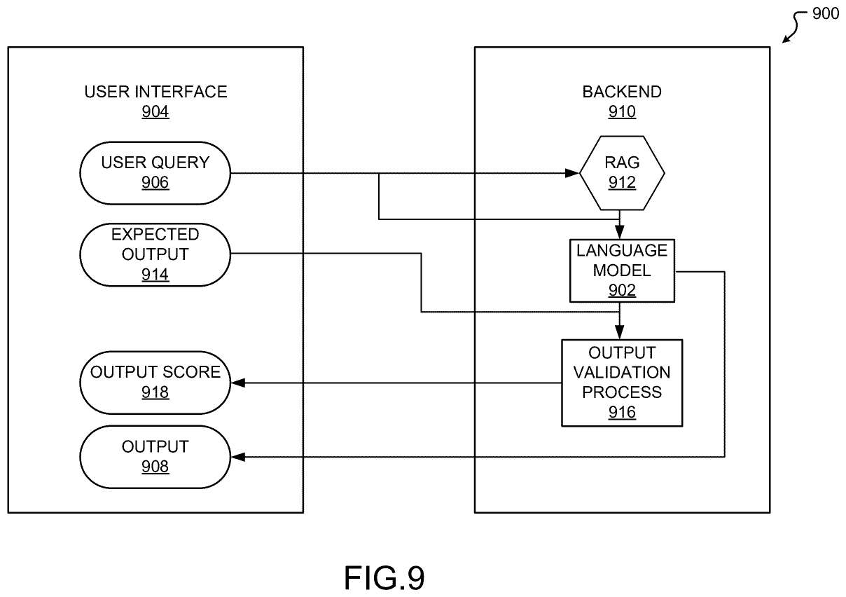

Turning to FIGS. 9-11, another embodiment of a scoring model and use of the scoring model in an example application will now be described.

FIG. 9 is a schematic diagram of a validation system (900) (“system (900)”) for a language model (902) according to at least one embodiment of the present disclosure. As shown, the validation system (900) includes a user interface (904) through which a user can submit a user query (906) to the language model (902). The user interface (904) may be, for example, a keyboard, mouse, trackball, monitor, television, screen, touchscreen, and/or any other device for receiving the user query (906) from the user and/or for providing an output (908) from the language model (902) to the user.

The user query (906) can include, for example, text, images, audio, or any combinations thereof and can be in the form of a prompt that instructs the language model (902) to generate the output (908). For example, the user query (906) can include a question for the language model (902) such as “What causes adjacency misalignment issues?”.

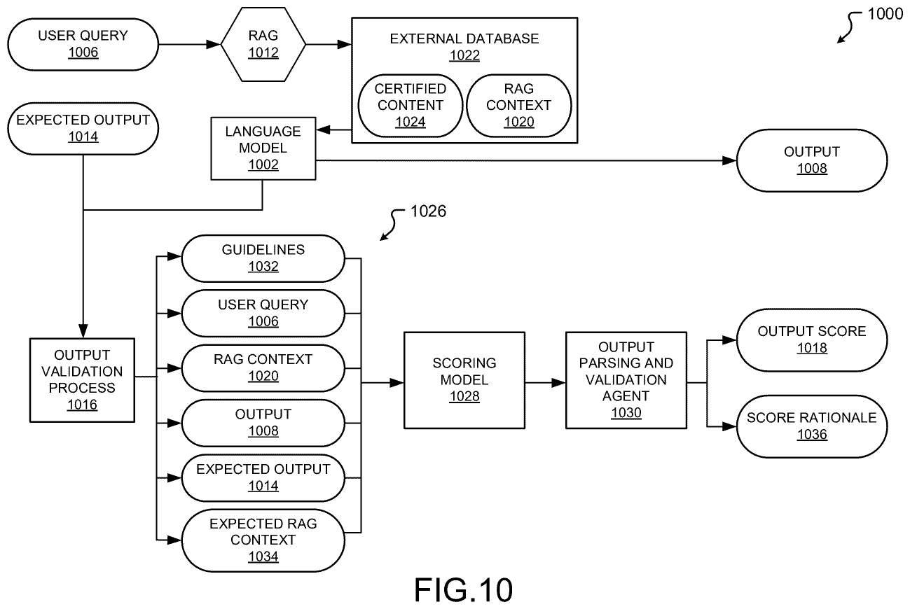

On a backend (910) of the system (900), the user query (906) is received by a Retrieval Augmented Generation (“RAG”) (912), which provides a RAG context (shown and described in detail in FIG. 10) to the language model (902). In some embodiments, the system (900) may not include the RAG (912) and the user query (906) may be received by the language model (902) without the RAG context.

The language model (902) receives the user query (906) and the RAG context and outputs an output (908) based on the user query (906) and the RAG context. The language model (902) is a natural language processing machine learning model. An example of the language model (902) may be a large language model (LLM), such as CHATGPT® or LLAMAR. However, many different language models may be used.

The output (908) can include, for example, text, images, audio, or any combinations thereof based on the instructions in the user query (906). For example, the output (908) can include an answer to the question in the user query (906) “What causes adjacency misalignment issues?”.

The output (908), an expected output (914), and one or more other inputs (e.g., the user query (906), the RAG context, etc.) are received as input by an output validation process (916), which will be described in detail in FIG. 10. The output validation process (916) includes a scoring model (shown and described in FIG. 10) that evaluates the output (908) based on one or more input information and outputs an output score (918), which correlates to an accuracy of the output (908) relative to an expected output (914) and other factors.

The output score (918) and the output (908) are then provided to the user via the user interface (904). The output score (918) may be provided as a percentage, a letter grade, or any other grading or scoring metric or label.

FIG. 10 is a detailed schematic diagram of a validation system (1000) (“system (1000)) for a language model (1002) according to at least one embodiment of the present disclosure. The system (1000) shown in FIG. 10 is a detailed example embodiment of the validation system (900) described in FIG. 9. It will be appreciated that the validation system (900), and more specifically, the output validation process (916) can be applied and used in any application such as, for example, any language models, LLMs, LLM/RAGs in which validation of an accuracy of an output is desired. The system (1000) described below is an example of one such application.

As shown, a user can submit a user query (1006) to a language model (1002). In the illustrated embodiment, the system (1000) includes a RAG (1012), which provides a RAG context (1020) with the user query (1006) to the language model (1002). In other embodiments, the system (1000) may not include the RAG (1012).

Generally, the RAG (1012) searches an external knowledge base (1022) that includes certified content (1024) that has been certified through a certification process. The RAG (1012) identifies certified content (1024) that is relevant to the user query (1006) and uses the identified certified content (1024) to generate the RAG context (1020) with the user query (1006) to the language model (1002). The RAG context (1020) can be in addition to context in the user query (1006) or can augment the context in the user query (1006).

Content that is provided to the external knowledge base (1022) can be in many different forms and is converted into vectors for storage in the external knowledge base (1022). It will be appreciated that in other embodiments, the content may be converted into any format for storage in the external knowledge base (1022). Prior to conversion, the content may be formatted based on one or more templates to case ingestion and conversion of the content. The content may also be partially certified through the certification process (whether formatted to a template or unformatted) prior to conversion. In other words, the certification process can certify the content prior to conversion of the content into the vector format and/or after conversion of the content into the vector format.

The certification process ensures that certified content (1024) in the RAG (1012) is of high quality and properly curated for application and use cases of the RAG (1012) and the language model (1002). The certification process also increases the accuracy of outputs from the language model (1002) when the content is validated after conversion. The certification process may include, for example, adding additional content or alternative text to a content to aid the language model (1002) or providing peer review confirmation for specific use cases of the content and ensuring that the content after conversion is valid.

The certification process used is selected from one or more certification processes based on a type of the content such as, for example, whether the content is a standard and/or specification, a technical journal, etc. For example, content that is already peer-reviewed and from a source of high-standards may have a certification process with different levels than content that has not been peer-reviewed. Several example embodiments of certification processes for different types of context will now be described.

An example embodiment of a certification process for standards and/or specifications where the content has a well contained and specific purpose can include the following certification levels:

1. No additions to the content itself, which is by nature peer reviewed with high quality.

2. Alternative text from an expert (i.e., a person with deep knowledge in a field) and/or alternative text from an authoritative source (i.e., reputable and trustworthy references and/or entities in a field) may be added to the content.

3. An expert team and/or peer review may add questions and answers (Q/A) pairs of sufficient coverage of the content, confirmed and reviewed answers, and/or automated Q/A testing. The Q/A can be designed to focus on, for example, assurance of specific use case applications and testing specific aspects of the RAG (1012) and/or language model (1002). For example, the Q/A can use poor grammar to test aspects of the language model's (1002) ability to comprehend. In another example, the Q/A can use a prompt with specific limitations to test the language model's (1012) ability or inability to follow limiting directions.

It will be appreciated that questions as described herein may include, for example, requests that are not phrased in the form of a question. In other words, the question can include a request of the language model (1002) that would result in a response or answer. For example, the request can include “provide an example of an adjacency misalignment” which would result in outputs from the language model (1002) that include examples of the adjacency misalignment.

4. In addition to level 3, expert confirmation Q/A testing may be added to the content.

5. Peer review confirmation for specific use cases may be added to the content.

Examples of such confirmation may include: does the use case's needs align with the purpose of the document and the Q/A testing that was conducted?

In another example embodiment, a certification process for content from technical conferences and/or technical journals in which content made be more general purpose can include the following certification levels:

1) No additions to the content itself, which may be lightly reviewed and not aligned to use cases as the content may be more general purpose.

2) No additions to the content itself if the content is aligned to use case categories.

3) The content may be peer reviewed for use case applications and ingestibility into the RAG (1012) and new context may be added to the content.

4) Expert provided alternative text may be added to the content. The alternative text can be provided either from the author of the content with peer review or an expert in the field.

5) Expert provided Q/A (either the author with peer review, or expert provided) for testing may be added to the content.

6) Automated review of the Q/A testing may be added to the content.

7) Expert review of the Q/A testing results may be added to the content.

8) Peer review confirmation for specific use cases may be added to the content. Examples of such confirmation may include: does the use case's needs align with the purpose of the document and the Q/A testing that was conducted?

In another example embodiment, a certification process of a RAG set or the RAG (1012) itself can include the following certification levels:

1) Content of the RAG (1012) is peer review content and/or content from a source authority.

2) The content are additionally peer reviewed.

3) Alternative text from experts and/or from a secondary source of experts are added to the content.

4) Q/As for the content are peer reviewed for testing.

5) The Q/As for the content are automatically tested.

6) The Q/A testing results are reviewed by expert(s) in the field; and

7) The content in the RAG (1012) are tested for specific use cases and sufficient results.

It will be appreciated that the certification processes described above are provided as example certification processes and the certification processes can include any number of levels and/or types of levels. Further, the certification process can include one certification process, two certification processes, or more than two certification processes.

Content being certified through the certification process may not go through all levels. For example, some content may go through two certification levels, while other content may go through all levels of the certification process. Such numbers of steps can be used to assign different certification levels based on the number of levels taken to certify the content. For example, content that is directly entered into the external knowledge base (1022) can be level 1 content and content that has gone through two steps of a certification process can be, for example, level 2 or level 1+ content. It will be appreciated that levels in any form (numerical, alphabetical, proportional, etc.) and any criteria can be used.

The certification level can be used, for example, by the language model (1002) or the RAG (1012) to weigh different certified content (1024). For example, certified content (1024) with higher certification levels may be weighted higher than certified content (1024) with lower certification levels and thus more deference may be given to the certified content (1024) with the higher certification level.

As previously described, the RAG (1012) provides the user query (1006) with the RAG context (1020) to the language model (1002), which generates an output (1008). As similarly described in FIG. 9, the output (1008) is validated using an output validation process (1016). The output validation process (1016) as shown includes a scoring model (1028) that scores the output (1008) based on one or more input information (1026). Output from the scoring model (1028) is then parsed or structured by an output parsing and validation agent (1030) into an output score (1038) and, optionally, a score rationale (1026).

The input information (1026) that is inputted into the scoring model (1028) includes, for example, one or more scoring guidelines (1032), the user query (1006), the RAG context (1020), the output (1008), an expected output (1014), and an expected RAG context (1034). The one or more scoring guidelines (1032) provides guidelines and instructions for the scoring model (1028) to score the output (1008) based on the input information (1026). For example, the scoring guidelines (1032) can include measuring an accuracy of the output (1008) relative to the RAG context (1020), measuring a relevancy of the output (1008) to the user query (1006), measuring an accuracy of the output (1008) relative to the user query (1006), measuring an accuracy of the RAG context (1020) to the expected RAG context (1034), and/or measuring a relevancy of the RAG context (1020) to the user query (1006). Such guidelines (1032) and set of input information (1026) enables the scoring model (1028) to more accurately evaluate the output (1008). For example, because the output (1008) is evaluated based on its relevancy to the user query (1006) and the RAG context (1020) in addition to the expected output (1014), inaccuracies due to wording that is not similar between the expected output (1014) and the output (1008) are reduced or eliminated.

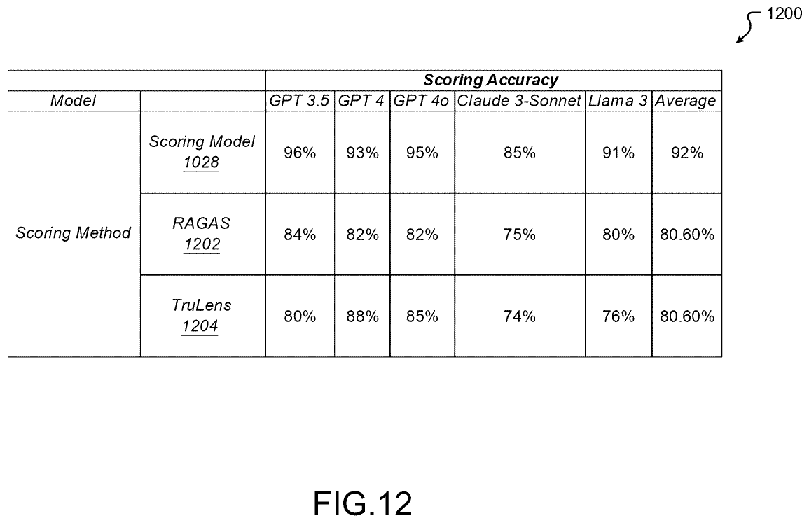

More specifically, the scoring model (1028) provided an improved scoring accuracy when tested and compared with other scoring tools such as, for example, RAGAS and TruLens. As shown in a table (1200) in FIG. 12, the scoring model (1028) had an average 11.4% increase in scoring accuracy compared to RAGAS (1202) and TruLens (1204) when tested on five test datasets. Thus, the enhanced accuracy provided by the scoring model (1028) provides an improved confidence in the system (1000) for evaluating and scoring outputs (1008) from the language model (1002).

As previously described, the output score (1018) may be provided as a percentage, a letter grade, or any other grading or scoring metric or label. The output score (1018) may also include more than one output score (1018) and can include two output scores (1018) or more than two output scores (1018). For example, the output score (1018) can include scores for an answer correctness, answer relevancy, context recall, faithfulness, answer similarity, and/or context relevancy. Similarly, the score rationale (1036) can include a corresponding number of score rationales (1036) for each output score (1018). The score rationale (1036) can include text that explains why the output (1008) was given the output score (1018). For example, if an output score (1018) is low (less than 50%), the score rationale (1036) may explain that the output (1008) does not align with the expected answer (1014) and may provide specific examples of the misalignment.

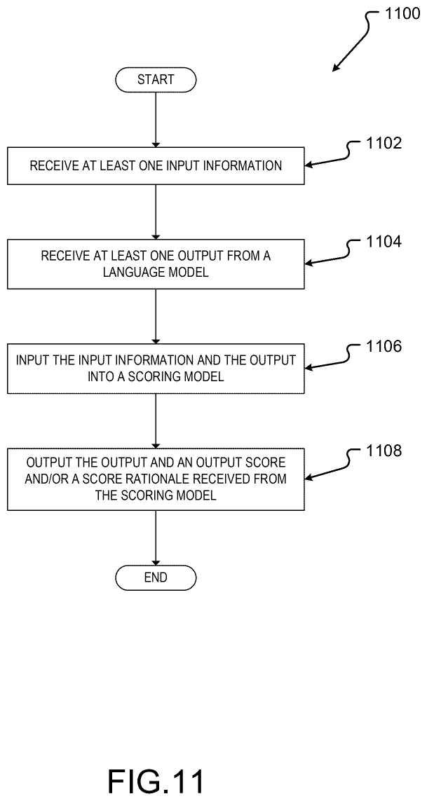

FIG. 11 is a dataflow of a method (1100) according to at least one embodiment of the present disclosure. The method (1100) can be used to validate and determine an accuracy of an output from a language model.

In step (1102) of the method (1100), at least one input information is received. The input information may be the same as or similar to the input information (1026) and may include, for example, one or more scoring guidelines such as the one or more scoring guidelines (1032), a user query such as the user query (906, 1006), RAG context such as the RAG context (1020), an expected output such as the expected output (1014), and an expected RAG context such as the expected RAG context (1034). The input information may be received from, for example, a language model such as the language model (902, 1002), a RAG such as the RAG (912, 1012), and/or a user interface such as the user interface (904).

Some of the input information may be stored in, for example, a database. For example, the guidelines, the expected RAG context and/or the expected outcome may be stored in a database and also retrieved from the database.

In step (1104) of the method (1100), at least one output such as the output (908, 1008) from the language model is received. The language model may be, for example, a large language model. Further, and as previously described, the language model can utilize the RAG, which is configured to search an external database and generate the RAG context for the user query. In such embodiments, the external database can include content that is certified through a certification process of one or more certification processes.

In step (1106) of the method (1100), the input information and the output are inputted into a scoring model such as the scoring model (1028). The scoring model may be, for example, a language model such as a large language model. In other embodiments, the scoring model may be any machine learning or artificial intelligence model. The scoring model uses the input information such as, for example, the guidelines to evaluate the output relative to the expected output, the user query, the RAG context, and/or the expected RAG context.

In step (1108) of the method (1100), the output and an output score such as the output score (1018) and/or a score rationale such as the score rationale (1036) received from the scoring model are outputted. As previously described, the output score may include more than one output score and the score rationale (if provided) may include a corresponding number of score rationales. The output, the output score, and the score rationale may be displayed in, for example, a graphical user interface (GUI) on a display of the user interface.

The method (1100) may include more or less steps. Further, the method or any step, steps, or combination of steps may be repeated. For example, the method (1100) may be repeated each time a user query is received.

Exemplary embodiments of systems and methods for evaluating an output of a language model using a scoring model are described above in detail. The systems and methods beneficially provide an improved accuracy in evaluating output(s) from a language model. Further, in embodiments where the language model utilizes a RAG with content that is certified through a certification process, the accuracy of the outputs from the language model are also improved. The systems and methods of this disclosure though, are not limited to only the specific embodiments described herein, but rather, the components and/or steps of their implementation may be utilized independently and separately from other components and/or steps described herein.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, i.e., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method comprising:
receiving at least one input information;
receiving at least one output from a language model;
inputting the at least one input information and the at least one output into a scoring language model configured to score the at least one output based on the at least one input information to yield an output score; and
outputting the at least one output from the language model and the output score.

2. The method of claim 1, wherein the language model uses a retrieval-augmented generation (RAG) configured to search an external knowledge base and generate a RAG context.

3. The method of claim 2, wherein the external knowledge base includes at least one content that is certified through a certification process of one or more certification processes.

4. The method of claim 3, wherein the certification process is selected based on a type of the at least one content.

5. The method of claim 4, wherein the certification process assigns a certification level to the at least one content based on at least one of the type of content and a number of steps taken during the certification process to certify the at least one content.

6. The method of claim 5, wherein the at least one content is weighted based on the assigned certification level.

7. The method of claim 1, wherein the at least one input information includes one or more scoring guidelines, a user query, a RAG context of the user query, an expected output, and an expected RAG context of the user query.

8. The method of claim 7, wherein the one or more scoring guidelines includes at least one of measuring an accuracy of the at least one output relative to the RAG context, measuring a relevancy of the at least one output to the user query, measuring an accuracy of the at least one output relative to the user query, measuring an accuracy of the RAG context to the expected RAG context, and measuring a relevancy of the RAG context to the user query.

9. The method of claim 8, wherein the RAG context of the user query is received from a RAG.

10. The method of claim 1, wherein the scoring language model further generates an output score rationale, and wherein the method further comprises outputting the output score rationale with the output score and the at least one output.

11. The method of claim 1, wherein outputting the at least one output and the output score comprises displaying the at least one output and the output score in a graphical user interface (GUI) on a display.

12. The method of claim 1, wherein the output score includes a plurality of output scores.

13. A system comprising:
a language model in communication with a user interface and configured to receive a user query as input and to output an output based on the user query;
a scoring language model in communication with the language model and the user interface, the scoring model configured to:
receive, as input, the output and at least one input information;
score the output based on the at least one input information; and
yield an output score; and
the user interface configured to display the output and the output score.

14. The system of claim 13, wherein the language model uses a retrieval-augmented generation (RAG) configured to search an external knowledge base and generate a RAG context.

15. The system of claim 14, wherein the external knowledge base includes at least one content that is certified through a certification process of one or more certification processes.

16. The system of claim 13, wherein the at least one input information includes one or more scoring guidelines, a user query, a RAG context of the user query, an expected output, and an expected RAG context of the user query.

17. The system of claim 16, wherein the one or more scoring guidelines includes at least one of measuring an accuracy of the at least one output relative to the RAG context, measuring a relevancy of the at least one output to the user query, measuring an accuracy of the at least one output relative to the user query, measuring an accuracy of the RAG context to the expected RAG context, and measuring a relevancy of the RAG context to the user query.

18. The system of claim 17, wherein the RAG context of the user query is received from a RAG.

19. The system of claim 13, wherein the scoring language model further generates an output score rationale, and wherein the method further comprises outputting the output score rationale with the output score and the at least one output.

20. A system comprising:
a language model in communication with a user interface and a RAG, the language model configured to receive a user query from the user interface and a RAG context from the RAG as input and to output an output based on the user query and the RAG context;
a scoring language model in communication with the language model and the user interface, the scoring model configured to:
receive, as input, the output, an expected output, the user query, the RAG context, an expected RAG context, and one or more scoring guidelines;
score the output based on the one or more scoring guidelines and the expected output, the user query, the RAG context, and the expected RAG context; and
yield an output score and a score rationale; and
the user interface configured to display the output, the output score, and the score rationale.
